(19) United States
(12) Patent Application Publication
(10) Pub. No.: US 2015/0307005 A1
(43) Pub. Date: Oct. 29, 2015

(54) VEHICLE SEAT

(71) Applicant: JOHNSON CONTROLS COMPONENTS GMBH & CO. KG, Kaiserslautern (DE)

(72) Inventors: Thomas DILL, Heiligenmoschel (DE); Wolfgang PLUTA, Heiligenmoschel (DE); Heinrich HAMMANN, Teschenmoschel (DE); Viktor ENNS, Kaiserslautern (DE)

(21) Appl. No.: 14/647,549

(22) PCT Filed: Nov. 27, 2013
(86) PCT No.: PCT/EP2013/074853

§ 371 Date: May 27, 2015

(30) Foreign Application Priority Data
Nov. 30, 2012 (DE) 10 2012 023 782.0
Feb. 27, 2013 (DE) 10 2013 003 787.5

(51) Int. Cl. B60N 2/68; B60N 2/22

(52) U.S. Cl. CPC B60N 2/68; B60N 2/22

(57) ABSTRACT

A vehicle seat (1) includes a first seat (11) with a first backrest (21) and a second seat (12) with a second backrest (22). The second backrest (22) is reinforced with at least one second longitudinal side piece (42, 44) formed from a frame part (52, 54). The first backrest (21) is reinforced with at least one first longitudinal side piece (41, 43) having an identical frame part (52, 54) and in addition a reinforcement part (51, 53, 55).

### CROSS REFERENCE TO RELATED APPLICATIONS

This application is a United States National Phase Application of International Application PCT/EP2013/074853 filed Nov. 27, 2013 and claims the benefit of priority under 35 U.S.C. §119 of German Patent Applications DE 10 2012 023 782.0 filed Nov. 30, 2012 and DE 10 2013 003 787.5 filed Feb. 27, 2013, the entire contents of each of which are incorporated herein by reference.

### FIELD OF THE INVENTION

The invention relates to a vehicle seat having a first seating position which comprises a first backrest and having a second seating position which comprises a second backrest.

### BACKGROUND OF THE INVENTION

DE 10 2007 011 874 A1 has disclosed a generic vehicle seat. The vehicle seat, which is designed as a rear seat, comprises two seat segments, wherein one of the seat segments comprises one seating position and the other seat segment comprises two seating positions. The two seat segments are arranged adjacent to one another and are displaceable in the direction of travel independently of one another by means of longitudinal adjusters.

A pivotable backrest is attached to the seat segment that comprises one seating position. The seat segment which comprises two seating positions has attached to it two backrests which are arranged adjacent to one another and which are pivotable about the same pivot axis relative to the seat segment.

### SUMMARY OF THE INVENTION

The problem addressed by the invention is that of improving a vehicle seat of the type mentioned in the introduction, in particular to realize a simplified construction by way of a modular design.

A generic vehicle seat has a first seating position, which comprises a first backrest, and a second seating position, which comprises a second backrest.

According to the invention, the second backrest is reinforced with at least one second longitudinal member which is formed from a frame part, and the first backrest is reinforced with at least one first longitudinal member which has an identical frame part and additionally a reinforcement part.

In this way, the first and second backrests can, by way of a modular design, be constructed substantially similarly even though different requirements may exist with regard to the strength of the first and second backrests.

This is relevant in particular if the first backrest, by contrast to the second backrest, has a seatbelt mechanism and must thus absorb seatbelt forces in the event of a crash, whereas the second backrest is subjected to considerably lower loads.

For an increase in strength, the second backrest advantageously has two longitudinal members for reinforcement, specifically a second right-hand longitudinal member, which is formed from a right-hand frame part, and a second left-hand longitudinal member, which is formed from a left-hand frame part.

The right-hand frame part and the left-hand frame part are in this case preferably of mirror-symmetrical form.

For an increase in strength, the first backrest advantageously also has two longitudinal members for reinforcement, specifically a first right-hand longitudinal member, which has a right-hand frame part and a reinforcement part, and a first left-hand longitudinal member, which has a left-hand frame part and a reinforcement part.

In one advantageous refinement of the invention, the first right-hand longitudinal member has a right-hand reinforcement part, and the first left-hand longitudinal member has a left-hand reinforcement part, wherein the right-hand reinforcement part and the left-hand reinforcement part are of mirror-symmetrical form.

In another advantageous refinement of the invention, the first right-hand longitudinal member has a right-hand reinforcement part and the first left-hand longitudinal member has an adaptation reinforcement part, wherein the adaptation reinforcement part is designed to be shorter in a vertical direction than the right-hand reinforcement part. In a further advantageous refinement of the invention, the first right-hand longitudinal member has an adaptation reinforcement part and the first left-hand longitudinal member has a left-hand reinforcement part, wherein the adaptation reinforcement part is designed to be shorter in a vertical direction than the left-hand reinforcement part. The relatively short adaptation reinforcement part is attached in particular to that side of the backrest at which a relatively low crash load is encountered in the event of a crash.

It is preferably the case that the first backrest has a first backrest panel and the second backrest has a second backrest panel, wherein the first backrest panel and the second backrest panel are of identical design.

It is advantageously the case that the first backrest has a first upper transverse member and the second backrest has a second upper transverse member, wherein the first upper transverse member and the second upper transverse member are of identical design.

A further reduction in the number of different individual parts can be realized if the first backrest and/or the second backrest have/has a lower transverse member which is of identical design to the first upper transverse member and to the second upper transverse member.

The upper transverse members are particularly advantageously designed as profile parts which have an at least approximately identical cross section over their entire extent in the transverse direction. The profile parts can be easily cut to the desired length from a rolled or pressed blank. Relatively simple variability of the widths of the backrests is thus possible.

It is preferably the case that the first backrest is pivotably attached to a first seat part and that the second backrest is pivotably attached to a second seat part.

It is advantageously also the case that a third backrest is pivotably attached to the first seat part and arranged laterally adjacent to the first backrest.

The first backrest can be locked to the third backrest if a locking device is arranged on the third backrest, which locking device interacts with a pin arranged on the first backrest.

Then, when the locking device is locked to the pin, the third backrest is pivotable together with the first backrest relative to the first seat part.

Below, the invention will be discussed in more detail on the basis of advantageous exemplary embodiments illustrated in the figures. The invention is however not restricted to these exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective illustration of a vehicle seat without cushioning;

FIG. 2 is an exploded illustration of a backrest blank;

FIG. 3 is an exploded illustration of a backrest;

FIG. 4 is a view showing construction kit components of the longitudinal members according to a first exemplary embodiment;

FIG. 5 is a view showing construction kit components of the longitudinal members according to a second exemplary embodiment; and

FIG. 6 is a horizontal sectional view through a backrest.

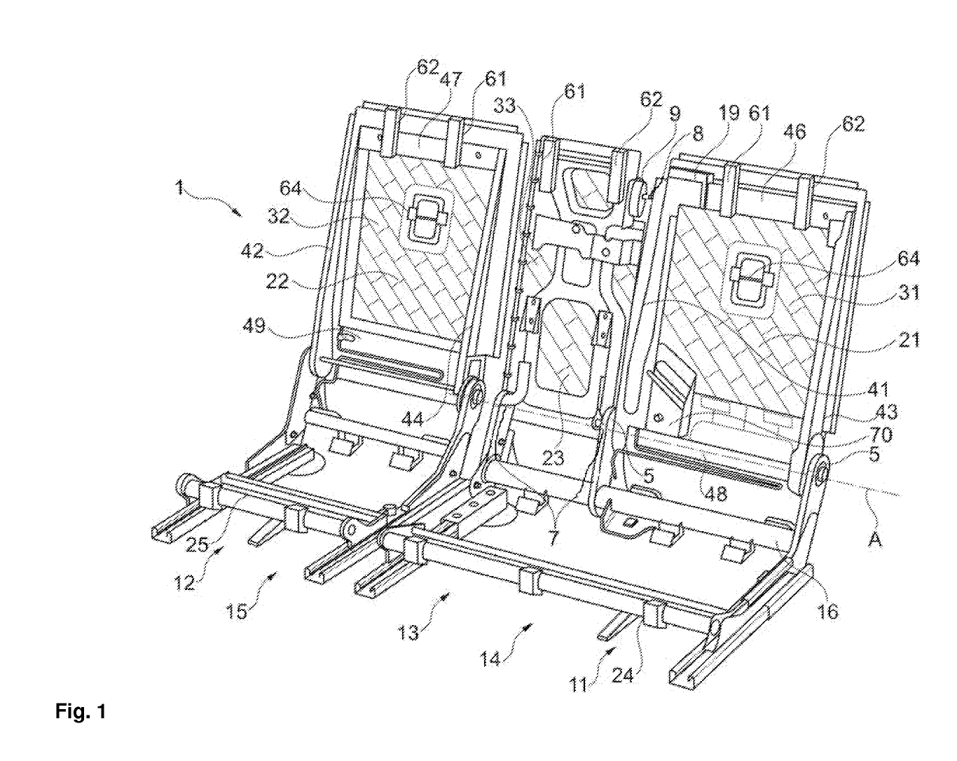

### DESCRIPTION OF THE PREFERRED EMBODIMENTS

A vehicle seat 1 is designed as a rear seat installation of a motor vehicle. The vehicle seat 1 comprises a first seat segment 14 with a first seat part 24 and a second seat segment 15 with a second seat part 25, which seat segments are connected to the vehicle structure of the motor vehicle so as to be longitudinally adjustable independently of one another by means of longitudinal adjusters.

The arrangement of the vehicle seat 1 within the vehicle and the normal direction of travel thereof define the directional designations used below. In this case, a direction oriented perpendicular to the ground is hereinafter referred to as vertical direction, and a direction perpendicular to the vertical direction and perpendicular to the direction of travel is hereinafter referred to as transverse direction. In the present case, the vertical direction also encompasses angles of up to 30° with respect to the vertical, and in particular, encompasses the orientation of a backrest of the vehicle seat 1 in an upright usage position when installed in the vehicle.

The first seat segment 14 accounts for approximately 60% of the total width of the vehicle seat 1, whereas the second seat segment 15 accounts for approximately 40% of said width. A first backrest 21 and a third backrest 23 are attached to the first seat part 24 so as to be pivotable about a pivot axis A, whereas a second backrest 22 is pivotably attached to the second seat part 25. The third backrest 23 is arranged in the transverse direction between the first backrest 21 and the second backrest 22. The pivot axis A runs horizontally in the transverse direction.

The first backrest 21 forms, with a part of the first seat part 24, a first seating position 11. The third backrest 23 forms, with a part of the first seat part 24, a third seating position 13. The second backrest 22 forms, with the second seat part 25, a second seating position 12. The first seating position 11 and the third seating position 13 are assigned to the first seat segment 14, and the second seating position 12 is assigned to the second seat segment 15.

The first backrest 21 comprises a first backrest panel 31 which is reinforced by means of a first right-hand longitudinal member 41, a first left-hand longitudinal member 43, a first upper transverse member 46, and a first lower transverse member 48. The third backrest 23 comprises a third backrest panel 33. The second backrest 22 comprises a second backrest panel 32 which is reinforced by means of a second right-hand longitudinal member 42, a second left-hand longitudinal member 44, a second upper transverse member 47 and a second lower transverse member 49. The first right-hand longitudinal member 41 of the first backrest 21 and the second left-hand longitudinal member 44 of the second backrest 22 each face toward the third backrest 23.

The second right-hand longitudinal member 42 is formed from a right-hand frame part 52. The second left-hand longitudinal member 44 is formed from a left-hand frame part 54. The right-hand frame part 52 and the left-hand frame part 54 are in this case of mirror-symmetrical design.

The first right-hand longitudinal member 41 is formed from a right-hand frame part 52 and a right-hand reinforcement part 51.

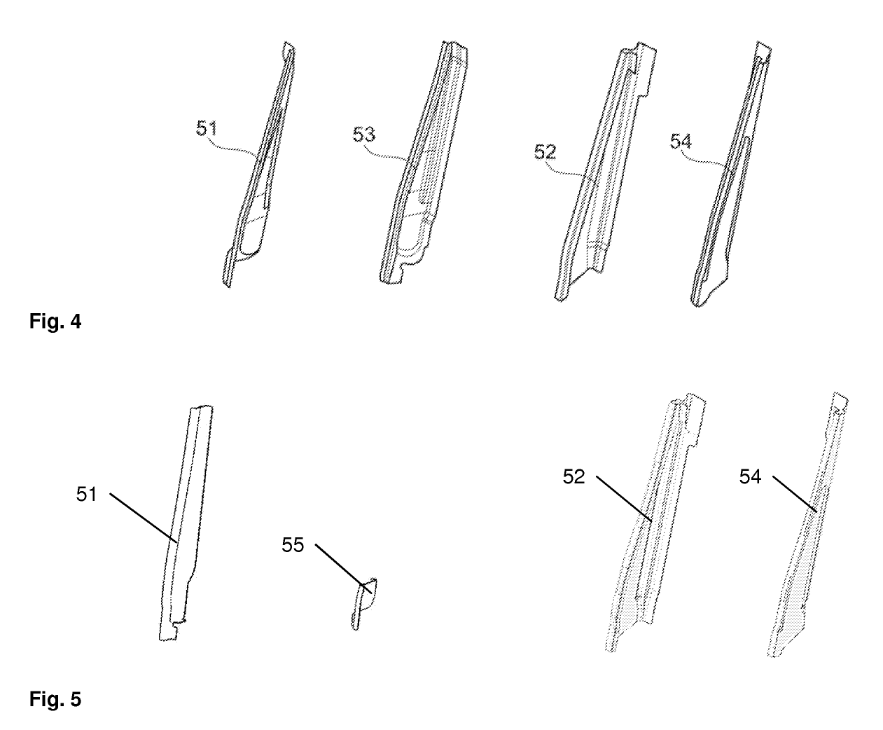

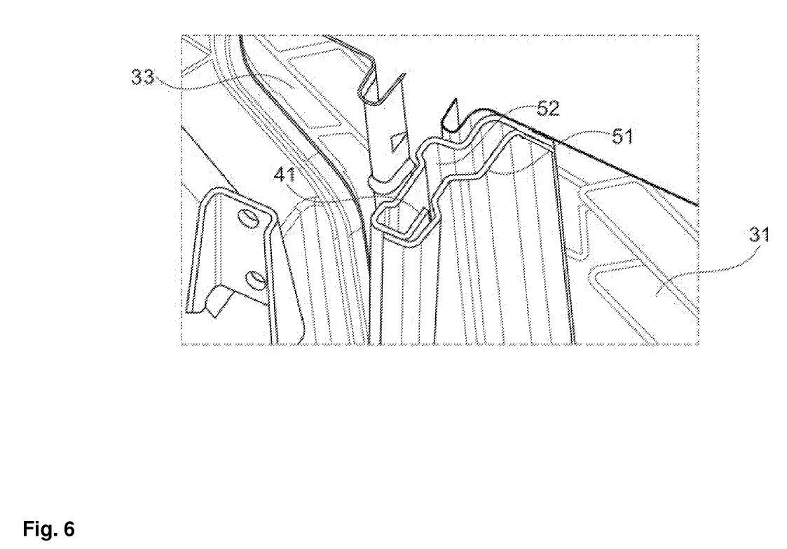

In a first exemplary embodiment illustrated in FIG. 4, the first left-hand longitudinal member 43 is formed from a left-hand frame part 54 and a left-hand reinforcement part 53. The right-hand reinforcement part 51 and the left-hand reinforcement part 53 are in this case of mirror-symmetrical design.

In a second exemplary embodiment illustrated in FIG. 5, the first left-hand longitudinal member 43 is formed from a left-hand frame part 54 and an adaptation reinforcement part 55. The right-hand reinforcement part 51 and the adaptation reinforcement part 55 are in this case not of mirror-symmetrical design. The adaptation reinforcement part 55, which does not need to absorb as high a load as the right-hand reinforcement part 51 in the event of a crash, is designed to be smaller, in particular shorter in a vertical direction, than the right-hand reinforcement part 51.

Thus, two identical right-hand frame parts 52 and two identical left-hand frame parts 54 are provided in the vehicle seat 1, specifically in each case in the first backrest 21 and in the second backrest 22.

From a manufacturing aspect, the mirror-symmetrical right-hand frame parts 52 and left-hand frame parts 54 can be produced using a first pressing tool.

Likewise, the mirror-symmetrical right-hand reinforcement parts 51 and left-hand reinforcement parts 53 used in the first exemplary embodiment can be produced using a second pressing tool. Thus, only two pressing tools are required for producing the four longitudinal members 41, 42, 43, 44 of the first exemplary embodiment.

Those reinforcement parts used in the second exemplary embodiment which are not mirror-symmetrical, specifically the right-hand reinforcement parts 51 and the adaptation reinforcement parts 55, can be produced using a third pressing tool.

Thus, it is likewise the case that only two pressing tools are required for producing the four longitudinal members 41, 42, 43, 44 of the second exemplary embodiment.

The first upper transverse member 46, the second upper transverse member 47 and the second lower transverse member 49 are each formed as identical profile parts 56. Thus, there are three identical profile parts 56 in the vehicle seat 1, specifically one in the first backrest 21 and two in the second backrest 22.

A profile part 56 is in this case a bar-like component which has an identical cross-section over its entire extent in the transverse direction.

The first lower transverse member 48 is in the present case designed as a square tube and thus differs from the profile part 56.

Each of the backrests 21, 22, 23 furthermore comprises in each case one first headrest mount 61, one second headrest mount 62 and one top tether bracket 64, which are likewise in each case of identical design.

Furthermore, the first backrest panel 31 of the first backrest 21 and the second backrest panel 32 of the second backrest 22 are of identical design.

The seat part 24, 25 and the backrests 21, 22, 23 are, in a known manner, provided with cushioning. The first backrest 21 and the second backrest 22 each account for approximately 40% of the total width of the vehicle seat 1, whereas the third backrest 23 accounts for approximately 20% of said width.

The first seat part 24 comprises a transverse tube 16 which runs in the transverse direction, parallel to the pivot axis A, and which extends approximately over the entire width of the first seat part 24 and thus also approximately over the entire width of the first seat segment 14.

The first backrest 21 is connected by means of two fittings 5 to the transverse tube 16 of the first seat part 24. The fittings 5 are in the present case of identical construction. Each fitting 5 has a first fitting part, which is fixedly connected to the first seat part 24, that is to say which is fixed with respect to the seat part, and a second fitting part which is fixedly connected to the first backrest 21, that is to say which is fixed with respect to the backrest, which fitting parts are pivotable relative to one another. The two fitting parts may, from a structural aspect, form a disk-shaped unit and be held together for example by way of a clasping ring.

In the present case, the fittings 5 are each in the form of locking fittings, that is to say the two fitting parts can be locked together by means of movable bolts. The bolts are moved into a locking position for example by way of a spring-loaded eccentric. By means of the fittings 5, the first backrest 21 can firstly be adjusted in terms of its inclination relative to the first seat part 24 into different usage positions, and can secondly be pivoted forward into a non-usage position.

The third backrest 23 is connected by means of two rotary bearings 7 to the transverse tube 16 of the first seat part 24. Close to the upper end, which faces away from the pivot axis A, of the third backrest 23 there is arranged a locking device 9 which interacts with a pin 8 provided on the first backrest 21.

When the locking device 9 is locked to the pin 8, the third backrest 23 is pivotable together with the first backrest 21 relative to the first seat part 24. When the locking device 9 is unlocked, the third backrest 23 can, independently of the first backrest 21, be pivoted forward relative to the first seat part 24 into the non-usage position.

Each of the three seating positions has a three-point seatbelt, wherein each three-point seatbelt comprises a seatbelt mechanism (not illustrated here). The seatbelt mechanisms of the first seating position 11 and of the second seating position 12 are each fastened to the vehicle structure.

The seatbelt mechanism of the third seating position 13 is fastened to the first backrest 21 of the first seating position 11. Thus, the seatbelt mechanism of the third seating position 13 is likewise situated in the first seat segment 14.

In the present case, the seatbelt mechanism of the third seating position 13 is arranged close to the pivot axis A and directly adjacent to the first right-hand longitudinal member 41 of the first backrest 21. A seatbelt web (not illustrated here) runs approximately parallel to the first right-hand longitudinal member 41 and parallel to the first backrest panel 31 from said seatbelt mechanism to a seatbelt diverting hoop 19 arranged close to the upper end, which is remote from the pivot axis A, of the first backrest 21 and thus also close to the pin 8.

The first backrest 21 has, for this purpose, a mounting panel 70 which accommodates the seatbelt mechanism (not illustrated) of the third seating position 13. The mounting panel 70 is arranged adjacent to the first right-hand longitudinal member 41 and above the pivot axis A. The mounting panel 70 is of substantially flat form and has a bend on the side remote from the first right-hand longitudinal member 41.

The mounting panel 70 lies against the first backrest panel 31. In the present case, the mounting panel 70 is connected, in particular welded, to the first right-hand longitudinal member 41 and to the first lower transverse member 48.

In the present case, the seatbelt mechanism (not illustrated) of the third seating position 13 lies against the mounting panel 70 and is connected, in particular screwed, thereto. For this purpose, in the present case, the mounting panel 70 has a protruding weld stud with external thread which projects through a fastening plate of the seatbelt mechanism and onto which there is then screwed a nut with internal thread.

The seatbelt diverting hoop 19 defines in this case a seatbelt outlet point for the seatbelt web of the third seating position 13. It is also conceivable for the seatbelt mechanism to be arranged close to the upper end, which faces away from the pivot axis A, of the first backrest 21 and close to the pin 8. In this case, the seatbelt diverting hoop 19 may be omitted if the seatbelt mechanism itself defines the seatbelt outlet point for the seatbelt web of the third seating position 13.

The seatbelt diverting hoop 19 is situated directly adjacent, in the transverse direction, to the first right-hand longitudinal member 41, which is situated directly adjacent to the associated fitting 5. The associated fitting 5, the right-hand longitudinal member 41 and the seatbelt diverting hoop 19 are thus situated approximately one above the other in the vertical direction and are offset relative to one another only slightly in the transverse direction.

When an occupant is sitting on the third seating position 13 and uses the associated seatbelt, it is thus the case in the event of a crash that the seatbelt web pulls on the seatbelt diverting hoop 19 forward in the direction of travel, and thus exerts a moment on the first backrest 21 about the pivot axis A. Said moment is transmitted from the first right-hand longitudinal member 41 to the fitting 5 and is introduced into the latter. The fitting 5 transmits the moment into the transverse tube 16, and from there, the moment is introduced, in the present case via the longitudinal adjuster, into the vehicle structure.

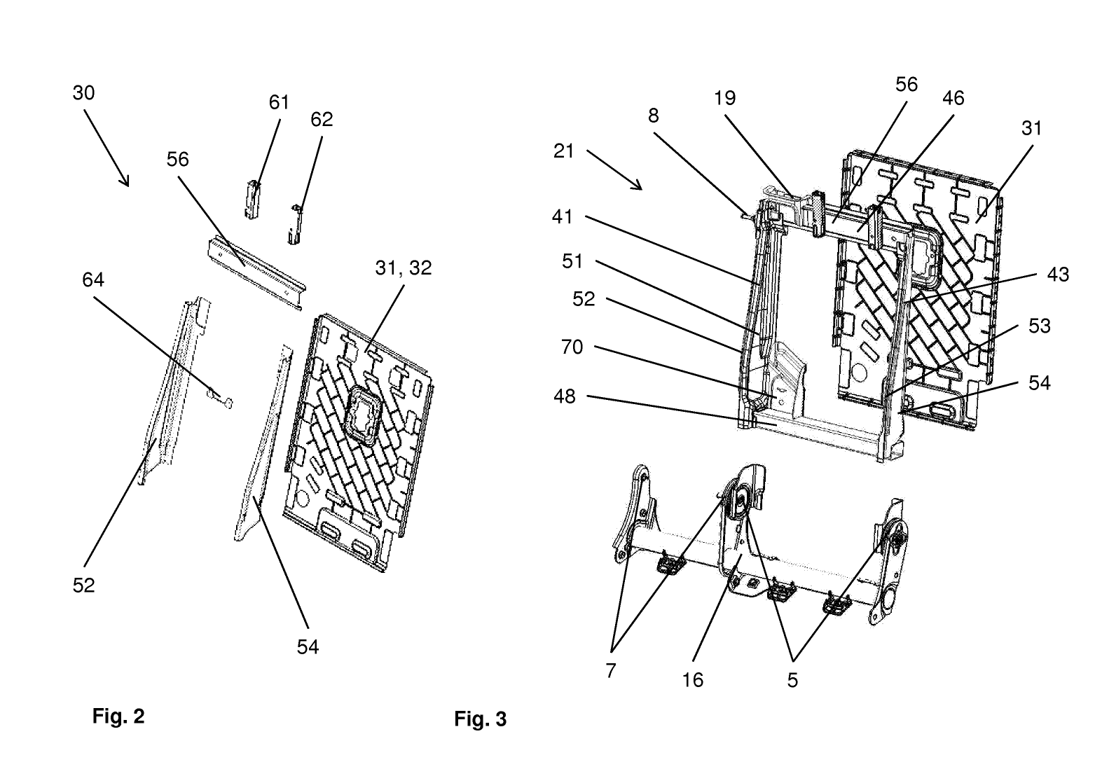

The first backrest 21 and the second backrest 22 are of substantially identical construction and each comprise a backrest panel 31 and 32 respectively, a right-hand frame part 52, a left-hand frame part 54, a profile part 56 as upper transverse member 46 and 47 respectively, and a first headrest mount 61, a second headrest mount 62 and a top tether bracket 64. A backrest blank 30 of said type is illustrated in FIG. 2.

The second backrest 22 additionally comprises a further profile part 56 as a second lower transverse member 49. The first backrest 21 additionally comprises the square tube as first lower transverse member 48, the reinforcement parts 51, 53, and/or the adaptation reinforcement part 55, the seatbelt mechanism, the seatbelt diverting hoop 19, the mounting panel 70 and the pin 8.

The features disclosed in the above description, in the claims and in the drawings may be of importance both individually and in combination for the implementation of the invention in its various embodiments.

While specific embodiments of the invention have been shown and described in detail to illustrate the application of the principles of the invention, it will be understood that the invention may be embodied otherwise without departing from such principles.

1. A vehicle seat comprising:
a first seating position which comprises a first backrest; and and
a second seating position which comprises a second backrest, wherein:
the second backrest is reinforced with at least one second backrest longitudinal member which is formed from a second backrest frame part; and
the first backrest is reinforced with at least one first backrest longitudinal member which has a first backrest frame part that is identical to the second backrest frame part and additionally a reinforcement part.

2. The vehicle seat as claimed in claim 1, wherein the at least one second backrest longitudinal member is comprised of a second backrest right-hand longitudinal member, which is formed from a right-hand frame part, and a second backrest left-hand longitudinal member, which is formed from a left-hand frame part.

3. The vehicle seat as claimed in claim 2, wherein the right-hand frame part and the left-hand frame part are of mirror-symmetrical form.

4. The vehicle seat as claimed in claim 1, wherein the at least one first backrest longitudinal member is comprised of a first backrest right-hand longitudinal member, which has a right-hand frame part and a reinforcement part, and a first backrest left-hand longitudinal member, which has a left-hand frame part and a reinforcement part.

5. The vehicle seat as claimed in claim 4, wherein the first backrest right-hand longitudinal member has a right-hand reinforcement part and the first backrest left-hand longitudinal member has a left-hand reinforcement part, wherein the right-hand reinforcement part and the left-hand reinforcement part are of mirror-symmetrical form.

6. The vehicle seat as claimed in claim 4, wherein the first backrest right-hand longitudinal member has a right-hand reinforcement part and the first backrest left-hand longitudinal member has an adaptation reinforcement part, wherein the adaptation reinforcement part is designed to be shorter in a vertical direction than the right-hand reinforcement part.

7. The vehicle seat as claimed in claim 4, wherein the first backrest right-hand longitudinal member has an adaptation reinforcement part and the first backrest left-hand longitudinal member has a left-hand reinforcement part, wherein the adaptation reinforcement part is designed to be shorter in a vertical direction than the left-hand reinforcement part.

8. The vehicle seat as claimed in claim 1, wherein the first back rest has a first backrest panel and the second backrest has a second backrest panel, wherein the first backrest panel and the second backrest panel are of identical design.

9. The vehicle seat as claimed in claim 1, wherein the first backrest has a first backrest upper transverse member and the second backrest has a second backrest upper transverse member, wherein the first upper transverse member and the second upper transverse member are of identical design.

10. The vehicle seat as claimed in claim 9, wherein the first backrest and/or the second backrest has a lower transverse member which is of identical design to the first upper transverse member and to the second upper transverse member.

11. The vehicle seat as claimed in claim 10, wherein the upper transverse members are designed as profile parts which have an approximately identical cross section over their entire extent in the transverse direction.

12. The vehicle seat as claimed in claim 1, wherein the first backrest is pivotably attached to a first seat part and in that the second backrest is pivotably attached to a second seat part.

13. The vehicle seat as claimed in claim 12, further comprising a third backrest pivotably attached to the first seat part.

14. The vehicle seat as claimed in claim 13, further comprising a locking device arranged on the third backrest, which locking device interacts with a pin arranged on the first backrest.

15. The vehicle seat as claimed in claim 14, wherein, when the locking device is locked to the pin, the third backrest is pivotable together with the first backrest relative to the first seat part.
